(19) United States
(12) Patent Application Publication
(10) Pub. No.: US 2004/0240852 A1
(43) Pub. Date: Dec. 2, 2004

(54) Disc recording apparatus and method with function of securing data recording area on disc

(76) Inventor: Takuro Hori, Osaka (JP)

Correspondence Address: Jonathan P. Osha, Osha & May L.L.P., Suite 2800, 1221 McKinney St., Houston, TX, 77010, US

(21) Appl. No.: 10/853,078

(22) Filed: May 25, 2004

(30) Foreign Application Priority Data
May 28, 2003 (JP) 2003-151111

(51) Int. Cl. H04N 5/781; G11B 7/00

(52) U.S. Cl. 386/95; 386/125

(57) ABSTRACT

In a case where a recording area of a disc is insufficient to record data thereon, a list is displayed of respective program titles of program data files on the recording area that have been deleted by being designated as non-reproducible. The user sees the displayed list and externally operates to select a desired file. The selected program data file is erased from the recording area of the disc so that a recordable area is secured. The user may externally input an instruction to cancel the designation of the deleted program data file as non-reproducible and thereby restore the data file to its original reproducible state. The restoring is accomplished by the mere cancellation of the designation and thus accompanied by no movement of files on the recording area.

### BACKGROUND OF THE INVENTION

1. Field of the Invention

The present invention relates to a disc recording apparatus and a disc recording method for recording data on such discs as DVD (Digital Versatile Disc) and HD (Hard Disk). In particular, the present invention relates to a disc recording apparatus and a disc recording method for securing, in a case where an available disc area is insufficient to record data thereon, a free disc area by erasing recorded data.

2. Description of the Background Art

In general, conventional HDD (Hard Disk Device) recorders having deleted a recorded file will never be able to reproduce the file.

Japanese Patent Laying-Open No. 2001-126449 discloses, for example, a method of deleting a recorded file of an HDD recorder, according to which a user can arbitrarily set a basis for selecting a file to be deleted upon writing of new data.

Further, Japanese Patent Laying-Open No. 2001-160264 proposes, for example, a method of predicting whether or not a free area on a recording medium to be written is insufficient according to program management information including program information, recording status of the recording medium and programming status.

Moreover, Japanese Patent Laying-Open No. 2001-257950 for example proposes that, in a case where there is no free space on a recording medium on which a broadcast program is to be written, a program to be erased is selected on a predetermined basis from programs having been recorded and the erased program is moved to a trash box so as to secure a free space. The above-referenced publication further proposes a procedure through which the program data moved for erasure to the trash box is restored into a reproducible state by a predetermined method.

According to the above-described conventional arts, once a recorded file is deleted, the deleted file is transferred to the trash box and may be read from the trash box at a user's request. Here, what is transferred to and read from the trash box is the file itself, resulting in an increase in load on the system.

### SUMMARY OF THE INVENTION

An object of the present invention is to provide a disc recording apparatus and a disc recording method with which deleted data can easily be restored.

In order to achieve the object above, according to an aspect of the present invention, the disc recording apparatus includes an erasure data selection unit for selecting, in a case where a recording area of a disc is insufficient to record data, a predetermined data group from at least one data group designated in advance as an erasure candidate, a-data erasure unit for erasing from the recording area the data group selected by the erasure data selection unit, and an erasure candidate cancellation unit for canceling the designation of the data group as the erasure candidate in response to an external input requesting to cancel the designation. That at least one data group designated as the erasure candidate is one of a plurality of data groups stored on the recording area of the disc, designated as the erasure candidate according to an external input and accordingly set in an unreadable state.

Thus, any data group which is designated as an erasure candidate according to an external input and is thus unreadable from the recording area can be restored to an original readable state by merely providing an external instruction to cancel the designation so that the erasure candidate cancellation unit cancels the designation.

The above-described restoring to the readable state is effected by mere cancellation of the designation and is accompanied by no movement of data group. Any load on the apparatus in restoring operation can thus be reduced.

Preferably, the erasure data selection unit includes a timing-based selection unit for selecting, according to timing when that at least one data group is designated as the erasure candidate, the predetermined data group from that at least one data group.

In this way, from at least one erasure candidate data group, a data group to be erased can be selected according to the timing when the data group is designated as an erasure candidate. For example, a data group designated at an earlier timing or a data group designated at a more recent timing may be selected.

Preferably, the erasure data selection unit includes an instruction-based selection unit for selecting, according to an externally input instruction, the predetermined data group from that at least one erasure group designated as the erasure candidate.

A data group to be erased from at least one erasure candidate data group can thus be selected according to an externally input instruction, for example, a user's request given through an external input by the user.

Preferably, to the data groups each stored on the recording area of the disc, flag data is allotted indicative of the designation as the erasure candidate or indicative of the cancellation of the designation as the erasure candidate and the flag data is changeable between the designation and the cancellation of the designation.

Designation as an erasure candidate or cancellation of the designation as the erasure candidate for each data group can thus be effected by changing the setting of the corresponding flag data.

Preferably, the disc reproducing apparatus further includes an erasure candidate title display unit for displaying a list of title of that at least one data group designated as the erasure candidate.

From the displayed list of respective titles of data groups designated as erasure candidates, a predetermined data group to be erased can be selected on the basis of the titles.

Preferably, the data group is program data on the basis of a television signal.

In order to accomplish the above-described object, according to another aspect of the present invention, a disc recording method includes an erasure data selection step for selecting, in a case where a recording area of a disc is insufficient to record data, a predetermined data group from at least one data group designated in advance as an erasure candidate, a data erasure step for erasing from the recording area the data group selected in the erasure data selection step, and an erasure candidate cancellation step for canceling the designation of the data group as the erasure candidate in response to an external input requesting to cancel the designation. That at least one data group designated as the erasure candidate is one of a plurality of data groups stored on the recording area of the disc, designated as the erasure candidate according to an external input and accordingly set in an unreadable state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of an HDD recording apparatus according to an embodiment of the present invention.

FIG. 2 schematically shows exemplary contents recorded on a disc.

FIGS. 3A and 3B illustrate a TID group.

FIG. 4 illustrates examples of a navigation list and a deleted-file list.

FIG. 5 is a flowchart showing an exemplary procedure for deleting a recorded file.

FIG. 6 is a flowchart showing an exemplary procedure for recording.

FIG. 7 is a flowchart showing an exemplary procedure for restoring.

FIG. 8 schematically shows other exemplary contents recorded on a disc.

FIG. 9 shows another example of the navigation list.

FIG. 10 is a flowchart showing another exemplary procedure for deleting a recorded file.

FIG. 11 is a flowchart showing another exemplary procedure for recording.

FIG. 12 is a flowchart showing another exemplary procedure for restoring.

### DESCRIPTION OF THE PREFERRED EMBODIMENTS

Embodiments of the present invention are hereinafter described with reference to the drawings. It is supposed here that data of programs received in the form of broadcast signals is recorded on a disc and that the program data is a group of data of a predetermined size to be recorded on the disc on a file-by-file basis for example. The data, however, may alternatively be recorded on another basis other than the file. Further, the data to be recorded is not limited to the program data. Moreover, the disc to be recorded may be DVD while the disc to be recorded here is HD.

First Embodiment

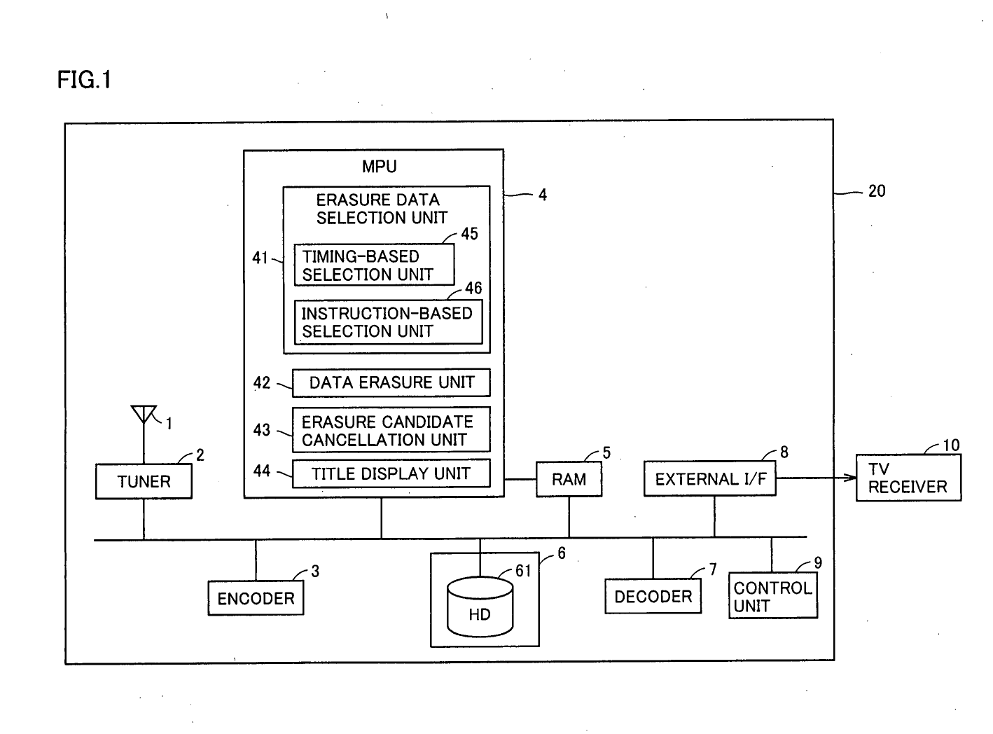

Referring to FIG. 1, an HD recording apparatus 20 includes an antenna 1, a tuner 2, an encoder 3, an MPU (Micro Processor Unit) 4, a RAM (Random Access Memory) 5, an HDD (Hard Disk Device) 6 for accessing (reading/writing) data from/on an internal-HD (Hard Disk) 61, a decoder 7, an external I/F (interface) 8 for connecting an external TV (television) receiver 10 for example, and a control unit 9. MPU 4 controls and monitors other components. MPU 4 includes an erasure data selection unit 41, a data erasure unit 42, an erasure candidate cancellation unit 43 and a title display unit 44. Erasure data selection unit 41 includes a timing-based selection unit 45 and an instruction-based selection unit 46. Respective functions of those components are implemented through execution of programs recorded in advance in an internal memory (not shown) by MPU 4.

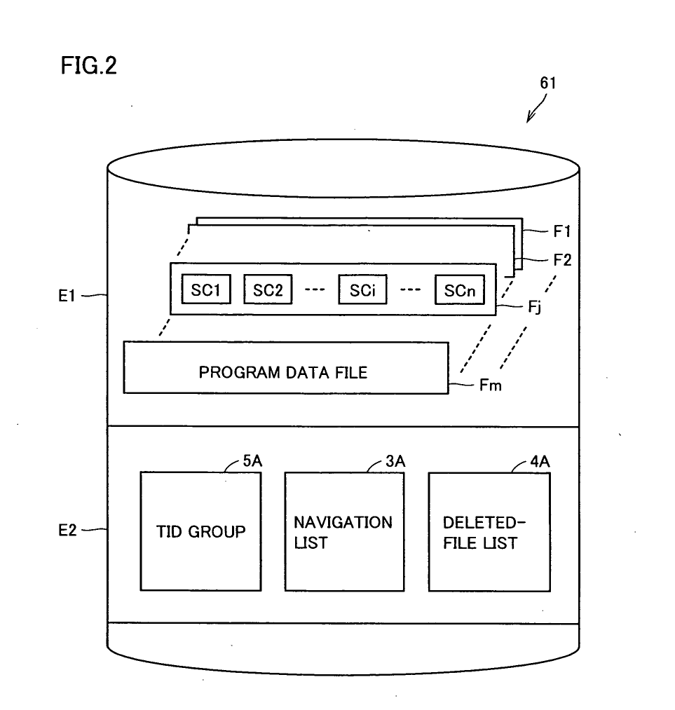

FIG. 2 shows exemplary contents of information concerning a program data file stored on HD 61. As shown in FIG. 2, HD 61 includes recording areas E1 and E2 for recording information thereon. On recording area E1, program data files Fj (j=1, 2, 3 . . . m) corresponding to respective programs are stored. Program data files Fj each include data components of the corresponding program data, for example, a plurality of sector data SCi (i=1, 2, 3 . . . n), each sector being a minimum unit for writing the corresponding program data on the disk.

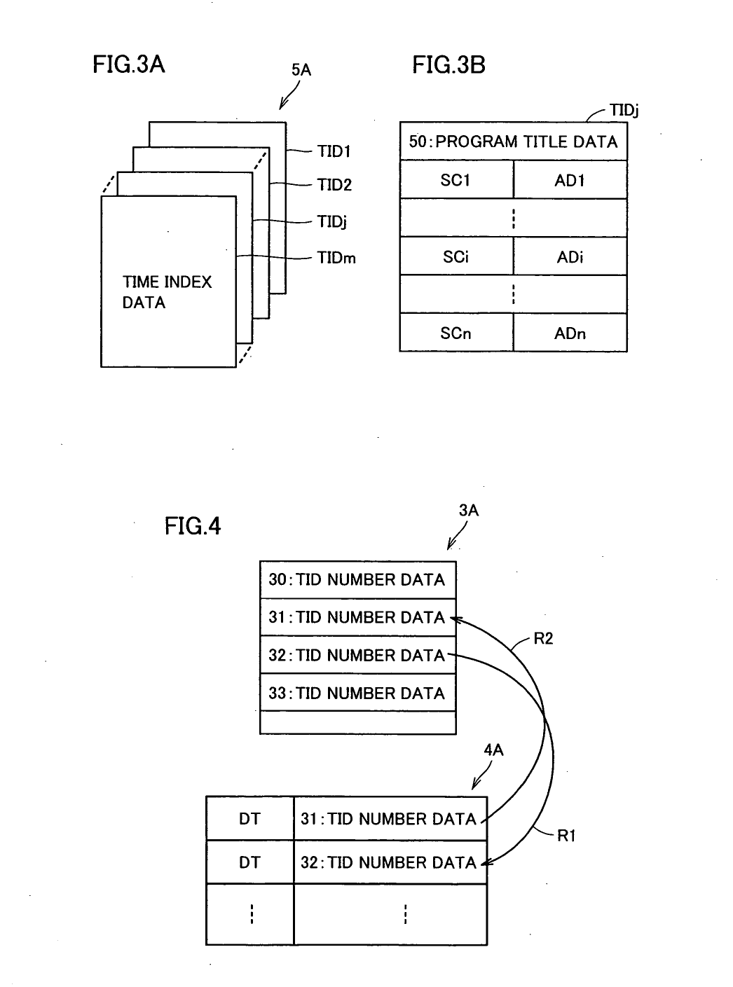

On recording area E2, a group of TID (Time Index Data) 5A, a navigation list 3A and a list of deleted files (hereinafter deleted-file list) 4A are stored. TID group 5A includes, as shown in FIG. 3A, TIDj (j=1, 2, 3 . . . m) corresponding to respective program data files Fj on recording area E1. TIDj each include, as shown in FIG. 3B, program title data 50 indicating the title of the corresponding program as well as address data ADi (i=1, 2, 3, . . . n) on recording area E1 for addressing corresponding sector data SCi of the corresponding program data file Fj.

Navigation list 3A includes, as shown in FIG. 4, TID number data 30, 31, 32, 33, . . . for uniquely indicating respective program data files Fj stored. on recording area E1 and in a reproducible state all the time. Thus, each TID number data in navigation list 3A can be used to retrieve and designate program data file Fj corresponding to TIDj in TID group 5A.

Deleted-file list 4A includes, as shown in FIG. 4, TID number data of at least one data deleted from navigation list 3A as well as registered date data DT indicating the date when the TID number data is deleted from navigation list 3A and registered in deleted-file list 4A.

TID group 5A, navigation list 3A and deleted-file list 4A on recording area E2 are read by MPU 4 from HD 61 through HDD 6 and transferred to RAM 5 in response to power-on of HD recording apparatus 20. Thus, during the power-on period, MPU 4 can refer to the information in RAM 5 so that the speed of processing can be enhanced as compared with the case where HD 61 is accessed. Upon power-off, the information in RAM 5 is transferred to and stored on recording area E2 of HD 61.

It is herein defined that, to copy TID number data in navigation list 3A that corresponds to program data file Fj on recording area E1 and register the TID number data in deleted-file list 4A is referred to as “to delete program data file Fj” and, to erase program data file Fj itself from recording area E1 that corresponds to the TID number data stored in deleted-file list 4A so as to generate a free area (new area where recording can be done) is referred to as “to erase program data file Fj”. The fact that program data file Fj corresponding to the TID number data is stored in deleted-file list 4A means that this program data file Fj is designated as a candidate for erasure. Further, “to restore” hereinlater discussed means that the designation as the erasure candidate is cancelled.

A description is now given of an operation of recording program data on the basis of TV broadcast signals received via antenna 1 and tuner 2 of HD recording apparatus 20. It is supposed here that the program data includes at least one of image data and audio data.

A user operates control unit 9 to designate a broadcast channel of a program that the user wants to watch. It is supposed here that control unit 9 provided for allowing the user to operate it and thereby enter information is a keyboard or switch for example that is integrated with HD recording apparatus 20. Alternatively, a remote controller (not shown) may be provided that is operated by the user to transmit an operation signal that is modulated and received in the form of an infrared signal by HD recording apparatus 20, so that HD recording apparatus 20 acquires what is designated by the user according to the received signal. The information about the channel thus designated is provided to MPU 4. MPU 4 controls tuner 2 according to the designated channel.

Antenna 1 receives and outputs TV signals transmitted from broadcast stations, and tuner 2 receives the TV signals received and output by antenna 1 to extract from the received TV signals a TV signal corresponding to the designated channel under control of MPU 4.

Encoder 3 receives the TV signal output from tuner 2 to encode the signal in accordance with MPEG (Motion Picture Experts Group) for example. Program data obtained through the encoding is recorded under control of MPU 4 on recording area E1 of HD 61 of HDD 6 on the sector data SCi basis and stored as program data file Fj. Here, MPU 4 generates TIDj for the stored program data file Fj and records TIDj in TID group 5A. TID number data indicating the TIDj recorded in TID group 5A is additionally registered in navigation list 3A. The TID number data in navigation list 3A and TIDj in TID group 5A are erased if the correlated program data file Fj is erased in the future.

A description is then given of an operation of reproducing a program data file stored on HD 61. A user operates control unit 9 to designate a desired program data file and instruct to reproduce the file. MPU 4 receives this instruction to read the designated program data file from HD 61 through HDD 6. The read program data is provided to decoder 7 where the data is decoded in accordance with MPEG into the original TV signal to be output to TV receiver 10 via external I/F 8 so that image display and audio output are effected.

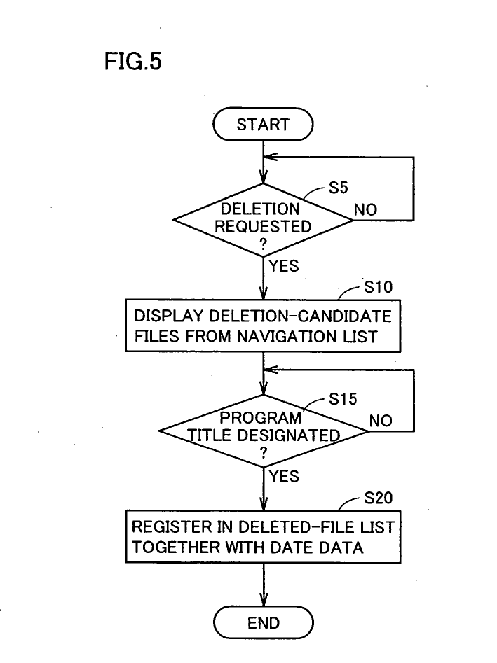

A procedure is described, following the flowchart shown in FIG. 5, of deleting program data files at user's requests from program data files Fj stored on recording area E1 and managing the deleted program files.

Following the procedure shown in FIG. 5, program data file Fj is deleted at the start of recording or during recording of program data on recording area E1.

A user operates control unit 9 to input a request to delete program data file Fj (YES in step S5). MPU 4 accepts this request, refers to navigation list 3A in RAM 5 to retrieve TIDj data of TID group 5A corresponding to respective TID number data 30, 31, 32, 33 . . . , reads respective program title data 50 of retrieved TIDj, and displays the read program title data 50 via external I/F 8 on TV receiver 10. Accordingly, a list of program titles indicated by program title data 50 of program data files Fj that can be deleted is displayed (step S10).

The user designates through control unit 9 a target program title in the list of program titles of respective files that are candidates for deletion (YES in S15). MPU 4 specifies, on navigation list 3A, TID number data of the designated program title, and additionally registers, in deleted-file list 4A, the specified TID number data together with registered date data DT correlated therewith that is timed by a timer (not shown) (step S20). The process of deleting a program data file in recording is thus completed.

Through the above-described procedure, TID number data 32 specified on navigation list 3A in FIG. 4 for example is moved to deleted-file list 4A in FIG. 4 as indicated by the arrow R1 and additionally registered therein. Thus, this TID number data 32 is deleted (erased) from navigation list 3A.

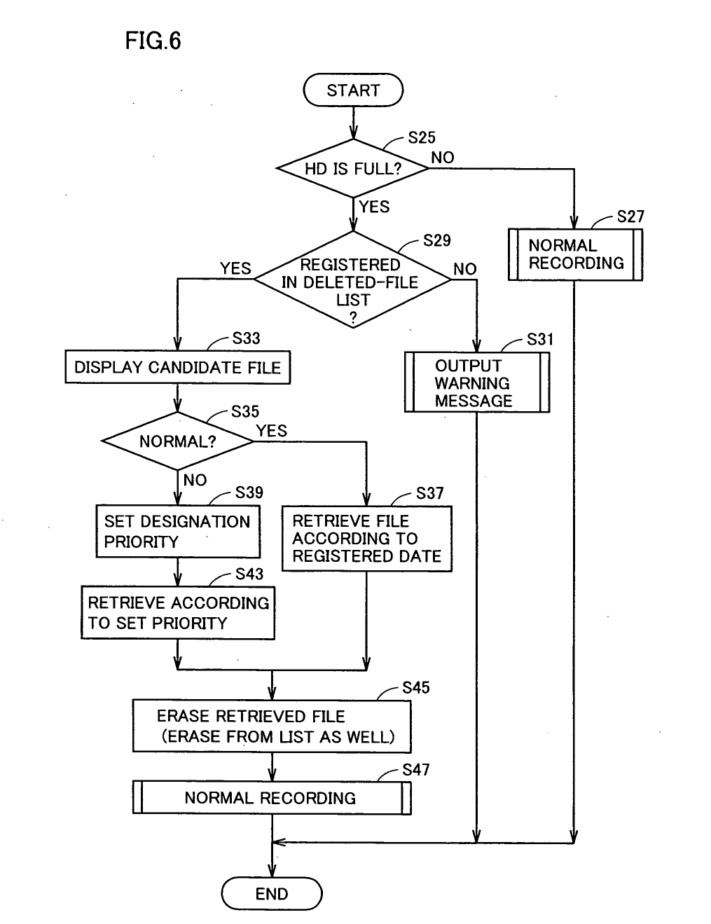

If MPU 4 detects, at the start or during recording of program data, a FULL state of recording area E1 on HD 61 (namely available recording area is insufficient to record new program data), MPU 4 then erases program data file Fj corresponding to TID number data registered in deleted-file list 4A so as to provide a resultant new free area as a recording area of the program data file. This procedure is described below with reference to FIG. 6.

When recording is started, MPU 4 determines whether or not there is a sufficient recording area for a program data file to be recorded this time on recording area E1 of HD 61, namely whether or not there is a recordable area (free area) for this program data file (step S25).

Specifically, with reference to TIDj each of TID group 5A in RAM 5, it is determined whether or not a difference between the capacity of a recording area occupied by all the used sector data SCi and the capacity of the maximum recordable area of recording area E1 is larger than the capacity of the recording area necessary for recording the program data file to be recorded this time.

If it is determined that there is left a recordable area for the program data file Fj on recording area E1 and accordingly FULL state is not found (NO in step S25), a regular recording process for received program data is carried out on recording area E1 on the sector data SCi basis (step S27). At this time, from EPG (Electronic Program Guide) data received together with the program broadcast signal, MPU 4 reads the title of the program. Then MPU 4 produces TIDj including program title data 50 indicating the read program title and respective address data ADi corresponding to recorded sector data SCi of the program, and stores the TIDj in TID group 5A. Further, after the program data is recorded, TID number data indicating the produced TIDj is registered in navigation list 3A (step S27).

In contrast, if it is determined that there is not left on recording area E1 a sufficient recordable area for the program data file Fj of the program to be recorded this time and a thus a FULL state is found (YES in step S25), MPU 4 refers to deleted-file list 4A in RAM 5 to determine whether or not deleted program data file Fj is registered (step S29). If no file is registered (NO in step S29), a warning message is displayed on TV receiver 10 (step S31). For example, a message for notifying “disc is full of data and this program cannot be recorded thereon” is output. This message may be displayed in the form of an image or output in the form of sound.

If at least one TID number data is registered in deleted-file list 4A (YES in step S29), title display unit 44 reads, for securing a recording area, program title data 50 corresponding to program data file Fj to be erased, and displays on TV receiver 10 a list of program titles indicated by the read program title data 50 (step S33).

More specifically, title display unit 44 searches TID group 5A, based on TID number data registered in deleted-file list 4A in RAM 5, for corresponding program title data 50 of TIDj and reads this program title data 50 for displaying in the form of a list on TV receiver 10 via external I/F 8.

According to the list of respective program titles of program data files Fj registered as candidates for erasure, the user designates through control unit 9 the program title of program data file Fj to be erased. This designation is effected by erasure data selection unit 41. Specifically, one of timing-based selection unit 45 and instruction-based selection unit 46 operates. In a normal mode, timing-based selection unit 45 operates (for effecting the designation in accordance with registered date data DT) (YES in step S35). In a non-normal mode, instruction-based selection unit 46 operates (NO in step S35). In the normal mode (YES in step S35), timing-based selection unit 45 specifies TID number data corresponding to registered date data DT in deleted-file list 4A in RAM 5 that indicates the oldest date and, based on the specified TID number data, searches TID group 5 for corresponding TIDj. According to respective addresses AD1-ADn of a plurality of sector data SC1-SCn of the TIDj, timing-based selection unit 45 accesses recording area E1 to retrieve corresponding program data file Fj. (step S37). After this, the process proceeds to step S45 hereinlater described.

In the non-normal mode (NO in step S35), the user can designate program data file Fj to be erased, on a user's own criterion (step S39). Specifically, the user refers to the list of the program titles displayed in step S33 and gives own priorities regarding designation of a file to be erased. For example, the user may designate program data file Fj having a character string “news” in the title indicated by program title data 50, or designate program data file Fj having the maximum data size (capacity).

According to the given priority, instruction-based selection unit 46 searches recording area E1 for retrieving program data file Fj to which the priority is given (step S43).

After this, data erasure unit 42 erases from recording area E1 the retrieved program data file Fj in the above-described procedure (step S45). At this time, data erasure unit 42 also erases corresponding information in navigation list 3A and corresponding information in deleted-file list 4A (step S45).

Then, new program data is recorded in a regular manner as described above (step S47). The recording process is thus completed.

It is supposed here that the titles of program data are displayed in the form of a list. Alternatively, the list-form display may selectively be done. In other words, the user may determine in advance whether or not the titles are to be displayed in the form of a list and if the list-form display is not employed, the user may directly input a target program by means of control unit 9 for designating the program.

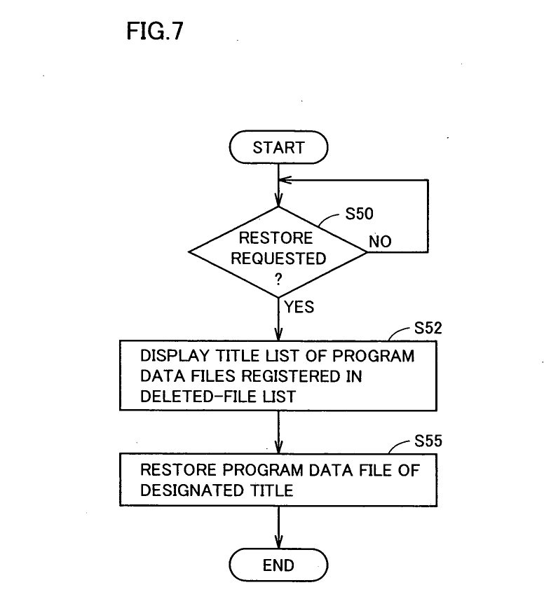

In this embodiment, program data file Fj that has been deleted and thus registered in deleted-file list 4A, namely program data file Fj in a non-reproducible state (cannot be read for being reproduced) may be returned to a reproducible state (can be read for being reproduced), which is herein referred to as “restore” following the procedure specifically described below in connection with the flowchart in FIG. 7.

A user operates control unit 9 to input a “restore” request (YES in step S50), title display unit 44 receiving this request searches TID group 5A, according to TID number data registered in deleted-file list 4A in RAM 5, for correlated TIDj, reads program title data 50 from the correlated TIDj, and then displays a list of titles indicated by the read program title data 50 on TV receiver 10 (step S52).

The user sees the displayed program title list and operates control unit 9 for designating a desired program title. Then, according to the designated program title, erasure candidate cancellation unit 43 searches TID group 5A for correlated TIDj and operates to restore program data file Fj corresponding to this TIDj (step S55).

More specifically, TID number data indicating the correlated TIDj found through the search is transferred from deleted-file list 4A to navigation list 3A for being additionally registered therein while this TID number data is erased from deleted-file list 4A. In this way, the designation as a candidate for erasure is canceled. For example, TID number data 31 in deleted-file list 4A shown in FIG. 4 is moved to navigation list 3A as indicated by arrow R2 (and accordingly TID number data 31 is erased from deleted-file list 4A) and additionally registered in navigation list 3A. The designation of the user-designated program data file Fj as a candidate for erasure is cancelled and accordingly restoring (transition to the reproducible state) of the file is completed (step S55).

While the titles of program data that can be restored are indicated in the form of a list by display unit 44, the user may arbitrarily determine whether or not the titles are displayed in the form of a list. If the list-form display is not employed, the user may operate control unit 9 to directly input and designate a program title.

Second Embodiment

Navigation list 3A and deleted-file list 4A are separately provided in the first embodiment. Alternatively, information of these lists may be registered together in a navigation list as done in a second embodiment. According to this embodiment, an HD recording apparatus 20 has its configuration similar to that shown in FIG. 1. Thus, components or features different from those of the first embodiment are hereinafter described and the description of identical ones is not repeated here.

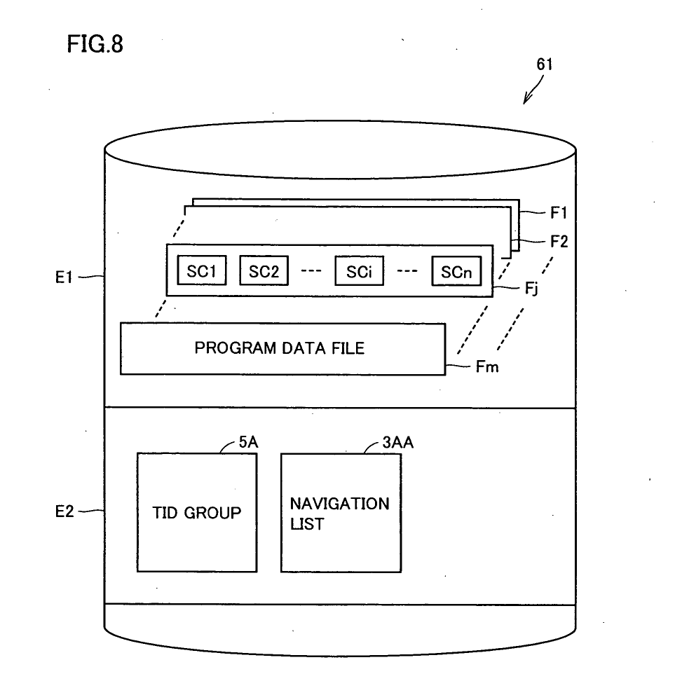

As shown in FIG. 8, a recording area E2 stores a TID group 5A as well as a navigation list 3AA where information of a navigation list 3A and information of a deleted-file list 4A are stored. Contents of a recording area E1 are similar to those of the first embodiment.

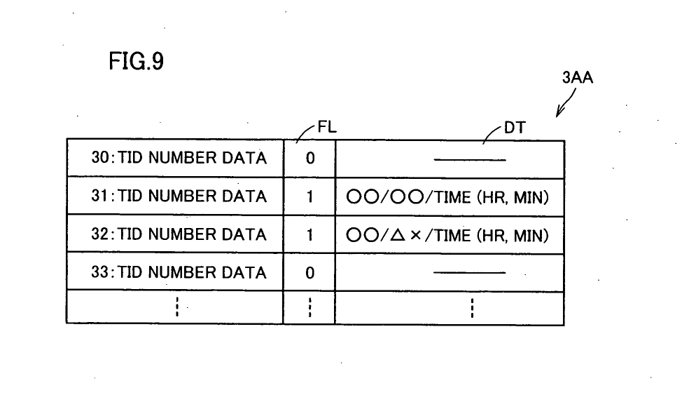

As shown in FIG. 9, in navigation list 3AA, TID number data 30, 31, 32, 33 . . . as well as flag data FL and registered date data DT correlated respectively with the TID number data are stored. Flag data FL is set to one of “0” and “1”. “0” indicates that program data file Fj of correlated TID number data is not deleted (reproducible state) while “1” indicates that program data file Fj of correlated TID number data has been deleted (non-reproducible state). As the first embodiment, registered date data DT indicates the date when program data file Fj of correlated TID number data is deleted and thus registered as a deleted file, namely the date when flag data FL is set to “1”.

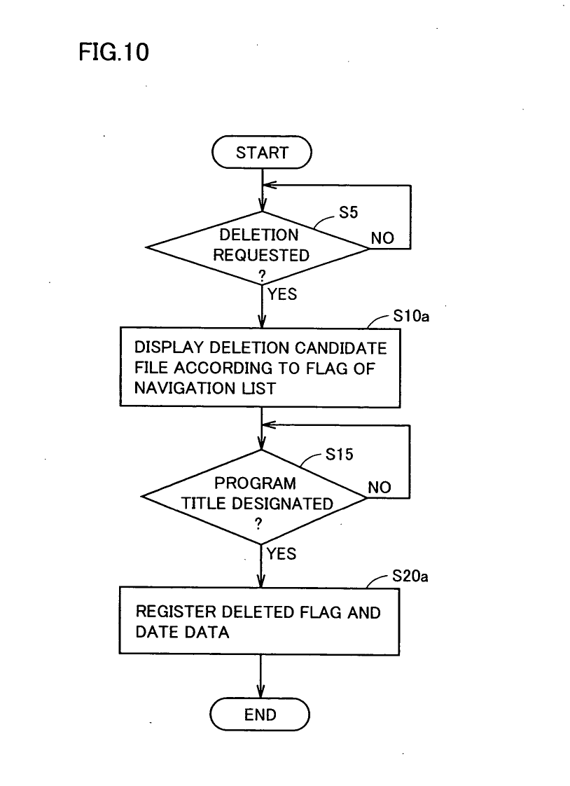

According to this embodiment, a recorded file is deleted following the procedure shown in FIG. 10. The procedure in FIG. 10 is similar to that in FIG. 5 of the first embodiment except that steps S10 and S20 in the first embodiment are replaced respectively with steps S10a and S20a. Thus, the operations in step S10a and S20a are hereinafter described specifically.

A user inputs a deletion request (step S5). Title display unit 44 searches navigation list 3AA to specify corresponding TID number data with flag data FL set to “0”. According to the specified TID number data, title display unit 44 searches TID group 5A for correlated TIDj, reads program title data 50 of the correlated TIDj and displays the titles indicated by the read program title data 50 in the form of a list (step S10a).

The user sees the title list and designates a program title the user desires to delete. Then, MPU 4 specifies TIDj of the designated program title, searches navigation list 3AA according to the TID number data indicating the specified TIDj to find flag data FL correlated with the specified TID number data, sets (changes) this flag data FL to “1” and sets date data at corresponding registered date data DT (step S20a). In this way, a deleted file can be registered by merely changing flag data FL.

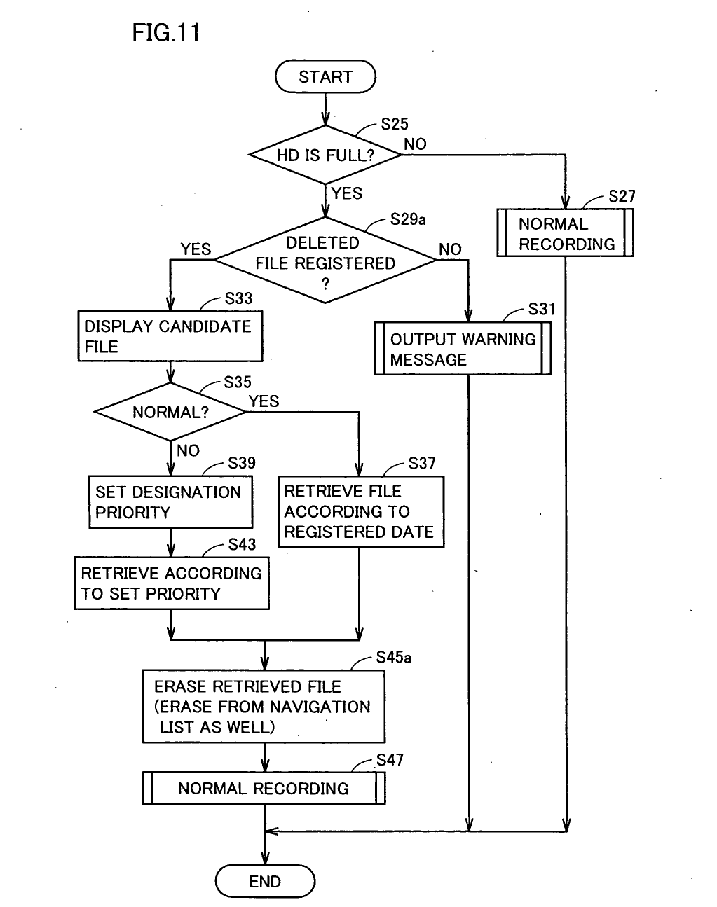

According to this embodiment, a program data file is erased as required in a recording process following the procedure in FIG. 11. The procedure in FIG. 11 and that in FIG. 6 of the first embodiment are similar to each other except that steps S29 and S45 in FIG. 6 are replaced respectively with steps S29a and S45a. A detailed description of respective operations of steps S29a and S45a is thus given below.

If a FULL state of HD 61 is detected in recording program data (YES in step S25), MPU 4 searches navigation list 3AA to determine whether or not any deleted file is registered therein by determining whether or not TID number data with correlated flag data FL set to “1” is registered (step S29a).

If any deleted files are registered, respective titles of programs are displayed in the form of a list. Then, a program data file to be erased is searched for according to the normal mode or non-normal mode (the mode according to the user-designated priority) (step S33-step S43).

Data erasure unit 42 erases program data file Fj thus found from recording area E1 while erasing correlated information (TID number data, flag data FL and registered date data DT) from navigation list 3AA and erasing correlated TIDj in TID group 5A (step S45a).

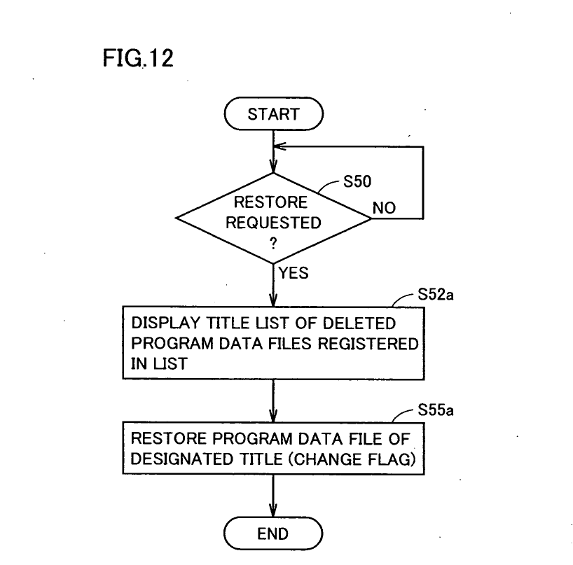

According to this embodiment, a recorded file is “restored” following the procedure shown in FIG. 12. The procedure in FIG. 12 is similar to that in FIG. 7 of the first embodiment except that steps S52 and S55 in FIG. 7 are replaced with steps S52a and S55a respectively. Then, a detailed description is given below of respective operations in steps S52a and S55a.

A user inputs a restore request, and then title display unit 44 searches navigation list 3AA to specify TID number data with correlated flag data FL set to “1”. According to the specified TID number data, TID group 5A is searched for specifying corresponding TIDj. Then, program title data 50 of the specified TIDj is read to display, according to the read program title data 50, a list of titles (step S52a).

After this, the user operates control unit 9 to designate a desired title in the program titles displayed in the form of the list. MPU 4 specifies TIDj of the designated program title in TID. group 50 and, according to the TID number data indicating the specified TIDj, searches navigation list 3AA and changes flag data FL corresponding to the specified TID number data from “1” to “0”. The “restoring” is thus completed.

As heretofore discussed, according to this embodiment, the value of flag data FL can be changed to register a file as a deleted file or restore the deleted file.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A disc recording apparatus comprising:
erasure data selection means for selecting, in a case where a recording area of a disc is insufficient to record data, a predetermined data group from at least one data group designated in advance as an erasure candidate;
data erasure means for erasing from the recording area the data group selected by said erasure data selection means; and
erasure candidate cancellation means for canceling the designation of said data group as the erasure candidate in response to an external input requesting to cancel the designation,
said at least one data group designated as the erasure candidate being one of a plurality of data groups stored on the recording area of said disc, designated as the erasure candidate according to an external input and accordingly set in an unreadable state.

2. The disc reproducing apparatus according to claim 1, wherein
said erasure data selection means includes timing-based selection means for selecting, according to timing when said at least one data group is designated as the erasure candidate, said predetermined data group from said at least one data group.

3. The disc reproducing apparatus according to claim 2, wherein
to said plurality of data groups each stored on the recording area of said disc, flag data is allotted indicative of the designation as the erasure candidate or indicative of the cancellation of the designation as the erasure candidate and said flag data is changeable between said designation and said cancellation of the designation.

4. The disc reproducing apparatus according to claim 3, further comprising erasure candidate title display means for displaying a list of title of said at least one data group designated as the erasure candidate.

5. The disc reproducing apparatus according to claim 4, wherein
the data group is program data on the basis of a television signal.

6. The disc reproducing apparatus according to claim 1, wherein
said erasure data selection means includes instruction-based selection means for selecting, according to an externally input instruction, said predetermined data group from said at least one erasure group designated as the erasure candidate.

7. The disc reproducing apparatus according to claim 6, wherein
to said plurality of data groups each stored on the recording area of said disc, flag data is allotted indicative of the designation as the erasure candidate or indicative of the cancellation of the designation as the erasure candidate and said flag data is changeable between said designation and said cancellation of the designation.

8. The disc reproducing apparatus according to claim 7, further comprising erasure candidate title display means for displaying a list of title of said at least one data group designated as the erasure candidate.

9. The disc reproducing apparatus according to claim 8, wherein
the data group is program data on the basis of a television signal.

10. The disc reproducing apparatus according to claim 1, wherein
to said plurality of data groups each stored on the recording area of said disc, flag data is allotted indicative of the designation as the erasure candidate or indicative of the cancellation of the designation as the erasure candidate and said flag data is changeable between said designation and said cancellation of the designation.

11. The disc reproducing apparatus according to claim 10, further comprising erasure candidate title display means for displaying a list of title of said at least one data group designated as the erasure candidate.

12. The disc reproducing apparatus according to claim 11, wherein
the data group is program data on the basis of a television signal.

13. The disc reproducing apparatus according to claim 1, further comprising erasure candidate title display means for displaying a list of title of said at least one data group designated as the erasure candidate.

14. The disc reproducing apparatus according to claim 13, wherein
said data group is program data on the basis of a television signal.

15. The disc reproducing apparatus according to claim 1, wherein
said data group is program data on the basis of a television signal.

16. A disc recording method comprising:
an erasure data selection step for selecting, in a case where a recording area of a disc is insufficient to record data, a predetermined data group from at least one data group designated in advance as an erasure candidate;
a data erasure step for erasing from the recording area the data group selected in said erasure data selection step; and
an erasure candidate cancellation step for canceling the designation of said data group as the erasure candidate in response to an external input requesting to cancel the designation,
said at least one data group designated as the erasure candidate being one of a plurality of data groups stored on the recording area of said disc, designated as the erasure candidate according to an external input and accordingly set in an unreadable state.
